(19) United States
(12) Patent Application Publication
(10) Pub. No.: US 2006/0123098 A1
(43) Pub. Date: Jun. 8, 2006

(54) Multi-system auto-failure web-based system with dynamic session recovery

(75) Inventors: Marc Asher, Highland Park, FL (US); James Kargman, Chicago, IL (US)

Correspondence Address: LEVENFELD PEARLSTEIN;Intellectual Property Department, 2 North LaSalle, Suite 1300, CHICAGO, IL, 60602, US

(73) Assignee: IPDEV, Chicago, IL (US)

(21) Appl. No.: 11/177,674

(22) Filed: Jul. 8, 2005

Related U.S. Application Data
(60) Provisional application No. 60/627,083, filed on Nov. 11, 2004.

(51) Int. Cl. G06F 15/16

(52) U.S. Cl. 709/218

(57) ABSTRACT

A method and computer operating system is disclosed to provide redundant hardware and software from multiple compatible computer operating systems and servers of a proprietary organization connected by a communication medium or connected on the Internet as a computer network as requested from said multiple servers by a specific host computer operating system per a transfer protocol.

This application is claiming the benefit of provisional application of U.S. Application Ser. No. 60/627,083, filed on Nov. 11, 2004.

### FIELD OF THE INVENTION

This invention relates to a computer operating system and method of operating the computer operating system to provide the ability to run multiple independent copies of a database and makes it possible for any connected database node to have an intact copy of the current state of the database. This invention provides redundancy for hardware and software connected as components of a multiple compatible computer operating system and computer network using a modem and telephone lines, coaxial cables, fiber optics, or microwaves, or any particular communication medium or a network on the World Wide Web connected to the Internet.

Multiple compatible computer operating systems of a business organization of computer networks, located either in one location, a local area network (LAN), or a wide area network (WAN) are connected using a modem and a communication medium or connected to a computer network on the World Wide Web of multiple web servers connected to the Internet. A protocol containing hypertext markup language (HTML) files containing a time-based unique number system code comprising a serialized transaction identifier (STI), a server applications program containing a hypertext transfer protocol (HTTP) and software such as a common gateway interface (CGI) script in response to a web server's request can be elements of the computer operating system.

Client systems protocol and web servers are connected to the client computer network and the World Wide Web and, based on the settings on a web page, are assigned to connect to specific host systems to allow said multiple computer systems to operate asynchronously with scalability, data integrity, real-time reporting and dynamic session state recovery to provide redundant hardware and software as requested by a web server protocol.

### BACKGROUND OF THE INVENTION

The invented multi-system auto-failover web-based system allows multiple geographically-distributed computer operating systems, accessible over a communication medium or the Internet, to perform as one system, with the ability to provide real-time consolidated data, reporting, and session recovery by clients dynamically across multiple operating systems, either as directed from a host web page or autonomously. The time-based unique number system code comprising a serialized transaction identifier permits a multi-system auto-failure web-based session recovery of stored information upon receiving a “recovery session” command to synchronize with client information and to proceed to provide services and information from a secondary host web page that the primary host web page would have provided had the primary host page been available.

Business information systems have become more and more dependant on computer-based information systems. At the same time, computer operating systems have become more powerful and more complex in operation modes. These developments have created a significant vulnerability in methods of using computer systems for business management procedures. Complex operating systems, including so-called “fault tolerant” systems comprise complex failure and recovery modes. Requirements for greater reliance and increasing dependence on fallible computer systems have made it imperative to develop operating systems to provide higher levels of reliability, or, essentially, to obtain “zero” downtime of computer operation. But problems typically occur. Fault tolerant operating systems are subject to failure modes. Databases are vulnerable to hardware and software malfunctions that can compromise their integrity and availability. Operating systems are vulnerable to mistakes made by system operators and programmers, and from intentional assault by unauthorized personnel either with malicious or criminal intent or to show that it is possible to “break into” computers and can be done.

From the viewpoint of the business management, the difference between a hardware subsystem failure or a database software system failure is not significant. What is important is that the organization's functions and financial results must not be hampered or affected and that the organization's operational activities continue without interruption, that the organization be able to recover from either computer hardware or software malfunction without loss of the operating system's integrity, security, or reliability.

The ability to provide redundancy for hardware and software of an operating system thus becomes significant. The instant invention comprises a method and a software operating system comprising a multi-system automatic failover web-based operating system that provides dynamic session recovery upon failure of hardware and software components. The instant invention provides an operating system with the ability to run multiple independent copies of a database, yet make it possible for any database node to have an intact copy of the current state of the database. This ability accordingly provides redundancy for hardware and software.

The instant invention comprises an operating system architecture that allows multiple systems to operate asynchronously, with scalability, data integrity, real-time reporting, and dynamic session-state recovery. The instant invented system architecture can operate on a variety of operating systems such as Microsoft Windows, DOS (Disk Operating System), Linux, Unix, Mac OS of Macintosh, and other operating systems.

### DESCRIPTION OF THE PRIOR ART

A number of hardware and software approaches have been developed to provide redundancy for hardware and software. However, the developed hardware and software, today, have not provided complete isolation from application or logic problems in an application of these hardware or software developments nor have these developments provided immunity to an external attack by unauthorized personnel.

An example of previous solutions to need for providing redundancy for hardware and software includes a fault tolerant system. The fault tolerant system is typically limited to two operating systems operating in “lockstep.” This limits scalability and does not provide redundancy for the database. Cluster systems provide scalability, but are still dependent on a single instance of a database, the database being susceptible to degradation through hardware failure, accidental or intentional damage.

Mechanical methods that provide redundancy by duplicating databases in real-time provide protection against physical damage to databases, but do not provide protection against logical transactions that include destructive commands such as present in non-viral malicious software. Sans (system area network software) can provide checkpoints and rollback, but cannot prevent a logical degrade of the primary database. Sans can only provide a failover procedure to a pair of redundant systems, which could also be logically degraded.

Other methods and systems that rely on a unique transaction number combined with a system number do not provide real-time reporting synchronization, since the sequence numbers do not contain any time or date information to make it possible to construct real-time data from distributed systems without coalescing all data from all systems. The coalescing procedure effectively defeats the purpose of distributing the workload for scalability among different systems, since the coalescing process requires a single system to coalesce all the data to be able to reconstruct accurate real-time reports. Previous mechanisms for failover do not anticipate autonomous failover with coordination through a redundant web farm for centralized control of system requirements.

In contrast to the above-described methods and system to provide redundant systems, the instant invented method and system provides significant advantages. The ability to add database servers as easily as it is to add web servers and other state machines makes it possible to both harden a database while it increases the performance capability. The ability to add redundant copies of critical customer and financial information, along with the ability to update this data asynchronously, yet retain the ability to construct real-time reporting based on any active nodes database, along with the ability to bring a node online without prior synchronization, provides the first hardened database system that is as redundant as the Internet and web page designs that typically front-end the database. With this technology, it is possible to connect networks in more than one location to databases in more than one location. Databases can be brought online and taken offline, and then resynchronized asynchronously, without losing the ability to construct real-time reporting based on current transactions.

The utility of the invented method and system is that it provides the ability to have redundant databases that are logically connected rather than physically. The invented method and system inherently protect against hardware malfunctions and specific problems with software. Logical filters can offer additional protection against logical database degradation, such as caused by operator or programmer error. The instant invention provides the ability to maintain multiple versions of the database with delayed journaling and with the ability to operate nodes without coordination; i.e., while inter-database communication is not yet available but still retain the ability to provide combined real-time reporting based on current transactions.

These capabilities have not been available with prior art mechanisms providing hardware and software redundancy.

Additionally, as provided by the instant invented method and system, the resynching of remote databases as provided by the instant invented method and system is a very fast process, since each database node only retains its own transactions for transmission to other databases. In a time-critical operation such as a call center selling a perishable product such as food or time-limited tickets as products, computer downtime is simply not an option, regardless of the cause. The instant invention provides a method and system to assure that an operating system is always available, that the loss of one system will be automatically compensated for by either an autonomous failover procedure or by direction of a failover system or procedure to another host operating system facility.

### SUMMARY OF THE INVENTION

The instant invention comprise a method for identifying and replicating system transactions to duplicate databases across hosts and system architecture to provide redundant hardware and software from multiple compatible computer operating systems of a proprietary organization's computer networks located geographically in one location as a local area network (LAN) or in a wide area network (WAN), the said computer network system architecture connected as a client computer network or the World Wide Web of multiple web servers connected to the Internet, so that a protocol of hypertext markup language files containing a time-based unique number system code containing a serialized transaction identifier runs a server program such as a hypertext transfer protocol, as well as software such as common gateway interface (CGI) script in response to another web server's request. Client operating system computers and web servers are connected on a client computer network or to the web farm on the World Wide Web on the Internet and, based on the settings on a web page, are assigned to connect to specific host systems to allow the said multiple computers systems to operate asynchronously with scalability, data integrity, real-time reporting, and with dynamic session state recovery to provide redundant hardware and software as requested by a web server. The invented method comprises said time-based unique number system code containing a serialized transaction identifier, which defines and sorts local host systems transactions by chronological order to display, replicate, and duplicate databases across hosts.

### DETAILS OF THE INVENTION

Multiple computer operating systems of a business organization located either in one location (LAN) or in multiple locations (WAN) are connected using a modem and communication medium or connected to a computer network on the World Wide Web of said business organization of multiple Internet servers. Client operating systems of the business organization are connected to said computer network. Based on the settings on a web page file of information contained on the web server computer, the client operating system is assigned to a specific host computer operating system of the business organization preferably located in a central location, either as a member of the LAN or of the WAN. Once the client operating system is logged into a specific host operating system, the transactions that then occur are stored in a memory of the client operating system using a data and time-based serial transaction identifier (STI) procedure wherein the client memory is subject to requests of the host operating system.

The instant invented method permits client operating computer systems to be connected to any operating system site of the business organization either at the LAN or WAN group, begin a transaction and, in the event of computer hardware or software failure, either autonomously select an alternate operating system of the business organization to complete the transaction, or, if able to be connected to one of the redundant web servers, take direction from the web server as to which alternate operating system site of the web farm to connect to complete the transaction.

The instant invented method for identifying and replicating system transactions to duplicate databases across hosts comprises a time-based number system containing a serialized transaction identifier (STI) procedure, which defines and sorts local host systems transactions by chronological order to identify, display, and replicate databases across hosts by object-oriented programming. The serialized transaction identifier (STI) procedure with embedded time sensitivity creates unique records in a database to identify, display, and replicate the transactions by means of the time-sensitive procedure for classifying transactions by time elements.

Each alternate operating system web site can recreate the stated date and time-based information on any specific host operating system, since each transaction is based on the STI procedure that is used in the host operating system. Once a transaction is completed, the data can be merged with other operating systems' transactions of other Internet servers, so that real-time data reporting is possible despite two separate client operating computer systems are receiving orders at exactly he same time.

The instant invention comprising an operating system architecture is based on the serial transaction identifier (STI) procedure, which permits multiple computer operating systems of a web farm to operate independently for short or long durations, but then have data taken independently by all computer operating systems of said web farm to be subsequently coalesced into a consistent set of data records that reflect transactions taken across all computer operating systems of the web farm. Each computer operating system is independent of waiting for another computer operating system of another computer operating system as each system requires a serial transaction identifier (STI) be generated before each system proceeds with its own set of transactions, which then can be coalesced.

The serial transaction identifier (STI) is a component of a global asynchronous serialized transaction identifier processing globally unique identifier (GUID) software comprising:

(a) a serial transaction identifier (STI) generation component;

(b) a cross-index validation component; and

(c) an asynchronous cross-system journaling component.

The STI generation component generates an identifier value for every transaction that is unique across all computer operating systems of the web farm.

The serial transaction identifier (STI) generation component (a) is generated in such a manner to allow transactions sequenced by this identifier to be coalesced at a later time on other member computer operating systems in a consistent chronological sequence. Generation of the identifier is done so as to be uniquely generated within a specific computer operating system, which may have multiple simultaneous processes involving separate transactions of the said computer operating system. The said computer operating system may also be a member operating system of multiple operating systems that are not in real-time communication with the said computer operating system.

The cross-index validation component (b) software creates multiple cross-index entries based on the serial transaction identifier (STI) component (a) so that internal consistency checks can be run in an audit function to verify sequential integrity of transactions generated on the local system, as well as validate the uniqueness of transaction identifiers generated across multiple systems.

The asynchronous cross-system journaling component (c) software involves established procedures for exchanging data records between multiple operating systems in a local area network (LAN) and/or wide area network (WAN). Raw data records indexed by STI are exported from each operating system generated by the source transaction and imported asynchronously to one or more member operating systems. The uniqueness of the STI ensures data elements are not over-written.

The STI is a single integer value limited to 19 digits derived from the following components:

(a) the date and time the STI was generated;

(b) a unique system ID on which the STI was generated; and

(c) a sequential identifier for multiple transactions generated at the identical date and time on the same system.

The key element is the chronological order of these components.

The format of the STI is as follows:

<Century Digit><Year Digit 1><Year Digit 2>

<Month Digit 1><Month Digit 2><Day Digit 1>

<Day Digit 2><Time Digits><Sequence Digits><System ID Digits>

The Century Digit is defined as the number of centuries since 1700. Year Digit 1 and Year Digit 2 represent the year of the transaction in 2-digit format. For example, the year 2003 would have a century Digit of 3, Year Digit 1 of 0, and Year Digit 2 of 3. The Month Digit 1 and Month Digit 2 combine to form a 2-digit representation of the month of the transaction with “01” representing January and 12 representing December. The Day Digit 1 and Day Digit 2 combine to form a 2-digit representation of the day in the month of the transaction. The Time Digits represent the time of the transaction in 24 hour HHMMSS format (hours-minutes-seconds with ‘0’ padding). The Sequence Digit is an incremental value starting arbitrarily at “1” and incremented makes multiple transactions which are taken at the identical time on the same system. The System ID Digits are a unique system identifier set for each member system. By using the date and then time as the “high order” values in the generated STI, any transactions using the identifier will be automatically sorted in a chronological manner regardless of the particular System ID Digits.

The cross-index validation component creates multiple cross-index entries based upon STI, so that internal consistency checks can be run to verify sequential integrity of transactions generated on the local system, as well as validate the uniqueness of the transaction identifiers generated across multiple systems.

The asynchronous cross-system journaling component involves established procedures for exchanging data records between multiple systems in a local are network (LAN) and/or wide are network (WAN) configuration. Raw data records indexed by STI are exported from each system generating the source transaction and imported synchronously to one or more member systems. The uniqueness of the STI ensures that date elements are not overwritten.

To utilize 32-bit processors under Windows and Linux/Unix, the system ID digits are limited to 19 digits.

In the cross-validation component there is generated an audit function, which is an integral part of the process that validates and assesses that all transactions are both generated as well as logged properly.

In the asynchronous cross-system journaling component that is provided, a journal filter process that assures that transactions originating in one system are not applied twice to the same system.

In the STI component, there is provided a method of distributed database activities establishing duplicate database to generate transactions that can later be coalesced into a consistent transaction image consistent with real-time business transactions.

In one process, the following number of transactions per second can be executed on the following number of systems:

| Systems Number | Transactions per Second |
|---|---|
| 999 | 999 |
| 99 | 9,999 |
| 9 | 99,999 |

It is known in the art to use transaction journaling—both before image journaling (an image of each block is taken before something is changed so that it can be replaced if the completion flag is not set) and after image journaling (each transaction also writes out a logical image of itself, which can then be applied to another database to reflect the same transaction). After image journaling is part of the specifications for the NSI standard (and Federal Information Processing Standard) M4MPS language (used in the Veteran's Administration, U.S. Air Forces, and most of the hospitals in the U.S.), which is the foundation of the technology in use today.

This novel system is able to scale an application asynchronously. This invention allows users to move operating system (OS) computers into and out of production without regard to the transactions, because time sequence inherent in the key structure allows the system to reconcile the transactions in real-time sequence across databases whether running at the same time or at different times.

The processing system of this invention uses a system ID digit with 19 or less digits to enable the system to operate on computers having 32 bits. Examples of these are Microsoft Windows and Linux.

The 32-bit processors are a broad category of environments in which integer precision is particularly adapted. The STI is a pure integer value. The use of a long integer value as opposed to a string value (containing alphanumerics) or a decimal value is advantageous in that it requires far less storage space on a system. The specific limitation of 19 digits is set because it is the level of integer precision available for a long multi-word integer value. Any longer value used for integer calculations or storage becomes truncated and would result in loss of data embedded within the formulation of the STI (i.e., the date/time/sequence/system identification).

The audit function comprises a component listed as the cross-index validation component (b). This component functions in cross-system journaling when a transaction is taken on system A, journaled and imported on system B, but then not subsequently journaled from system B to be loaded on system A (in effect creating an infinite loop). The audit function is an included function within the invention database environment. The presence of this function is essential to distribute transactional processing across multiple systems.

The limitation of 999 transactions per second on a single system is not easily overcome while maintaining the STI as a 19-digit integer value owing to the fact that additional digits cannot be allocated for this single system serialization component or otherwise data loss will occur as the long integer digit precision will be overrun. Similarly, 19-digit formulation of the STI is also only suitable for up to 999 member servers, as only 3 digits are allocated for the server identification. However, all these limitations are overcome by transitioning from a pure integer index value to an alphanumeric value of arbitrary length. The alphanumeric value allows for additional digit positions for the single system serialized index component, as well as for the system identification. The primary downside of shifting to a non-integer index value from a conceptual standpoint is the increase in storage required for the values. From an implementation-specific standpoint, the system has implemented this indexing scheme to not require several added components, if an integer transaction number is rewritten.

The instant invention accordingly relates to a computer operating system to provide a computer operating system to provide redundant hardware and software from multiple compatible computer operating systems and software of a proprietary organization's computer network and software located geographically in one location as a local area network (LAN) and in a wide area network (WAN) to any compatible computer operating system and software of said LAN and WAN, the said computer network connected as a computer network using a modem and a communication medium and using a computer network on the World Wide Web as multiple servers connected to the Internet, wherein said computer operating system comprises: (a) a protocol containing a global asynchronous serialized transaction identifier processing system comprising at least three software components: (i) a serialized transaction identifier (STI) generating component, (ii) a cross-index validation component, and (iii) an asynchronous cross-system journaling component; (b) a plurality of compatible computer operating systems; and (c) a plurality of compatible computer software routines adapted to be executed on said compatible computer operating systems to program said computer operating systems to execute transactions providing back-up redundancy of transactions from other compatible computer operating systems.

In further detail, the instant invention comprises a computer operating system wherein compatible computer operating systems of said proprietary organization's computer networks and software are client operating systems connected to said computer operating system using a modem and a communication medium.

In further detail, the instant invention comprises a computer operating system wherein compatible computer operating systems of said compatible computer operating systems of said proprietary organization's computer networks and software and client operating systems connected to said computer operating system using the World Wide Web of multiple web servers connected to the Internet.

In further detail, the instant invention comprises a computer operating system wherein a specific host computer operating system serves as the computer network server computer.

In further detail, the instant invention comprises a computer operating system wherein said multiple compatible computer operating systems are logged into a specific host computer operating system as instructed by the computer network server computer program.

In further detail, the instant invention comprises a computer operating system wherein transactions that occur on said compatible computer operating systems are stored in said compatible computer operating systems memory by means of said global asynchronous serialized transaction identifier processing system.

In further detail, the instant invention comprises a computer operating system wherein transactions that occur on said compatible computer operating systems and are stored in said compatible computer operating systems by means of said global asynchronous serialized transaction identifier are subject to transfer requests of a host operating system.

The instant invention accordingly relates to a method for identifying and replicating system transactions to duplicate databases across host systems, said method comprising (a) a time-based number system containing a serialized transaction identifier procedure, which defines and sorts local host systems transactions by chronological order to identify, display, and replicate databases across hosts by object-oriented programming, and (b) a computer operating system to provide redundant hardware and software from multiple compatible computer operating systems and software of a proprietary organization's computer network and software located geographically in one location as a local area network (LAN) and in a wide area network (WAN) to any compatible computer operating system and software of said LAN and WAN, the said computer network connected as a computer network using a modem and a communication medium and using a computer network on the World Wide Web as multiple servers connected to the Internet, wherein said computer operating system comprises: (i) a protocol containing a global asynchronous serialized transaction identifier processing system comprising at least three software components, (1) a serialized transaction identifier (STI) generating component, (2) a cross-index validation component, and (3) an asynchronous cross-system journaling component; (ii) a plurality of compatible computer operating systems; and (iii) a plurality of compatible computer software routines adapted to be executed on said compatible computer operating systems to program said computer operating systems to execute transactions providing back-up redundancy of transactions from other compatible computer operating systems.

What is claimed is:

1. A computer operating system to provide redundant hardware and software from multiple compatible computer operating systems and software of a proprietary organization's computer network and software located geographically in one location as a local area network (LAN) and in a wide area network (WAN) to any compatible computer operating system and software of said LAN and WAN, the said computer network connected as a computer network using a modem and a communication medium and using a computer network on the World Wide Web as multiple servers connected to the Internet, wherein said computer operating system comprises:
(a) a protocol containing a global asynchronous serialized transaction identifier processing system comprising at least three software components:
(i) a serialized transaction identifier (STI) generating component,
(ii) a cross-index validation component, and
(iii) an asynchronous cross-system journaling component;
(b) a plurality of compatible computer operating systems; and
(c) a plurality of compatible computer software routines adapted to be executed on said compatible computer operating systems to program said computer operating systems to execute transactions providing back-up redundancy of transactions from other compatible computer operating systems.

2. The computer operating system of claim 1 wherein compatible computer operating systems of said proprietary organization's computer networks and software are client operating systems connected to said computer operating system using a modem and a communication medium.

3. The computer operating system of claim 1 wherein compatible computer operating systems of said compatible computer operating systems of said proprietary organization's computer networks and software and client operating systems connected to said computer operating system using the World Wide Web of multiple web servers connected to the Internet.

4. The computer operating system of claim 1 wherein a specific host computer operating system serves as the computer network server computer.

5. The computer operating system of claim 1 wherein said multiple compatible computer operating systems are logged into a specific host computer operating system as instructed by the computer network server computer program.

6. The computer operating system of claim 1 wherein transactions that occur on said compatible computer operating systems are stored in said compatible computer operating systems memory by means of said global asynchronous serialized transaction identifier processing system.

7. The computer operating system of claim 1 wherein transactions that occur on said compatible computer operating systems and are stored in said compatible computer operating systems by means of said global asynchronous serialized transaction identifier are subject to transfer requests of a host operating system.

8. A method for identifying and replicating system transactions to duplicate databases across host systems, said method comprising (a) a time-based number system containing a serialized transaction identifier procedure, which defines and sorts local host systems transactions by chronological order to identify, display, and replicate databases across hosts by object-oriented programming, and (b) a computer operating system to provide redundant hardware and software from multiple compatible computer operating systems and software of a proprietary organization's computer network and software located geographically in one location as a local area network (LAN) and in a wide area network (WAN) to any compatible computer operating system and software of said LAN and WAN, the said computer network connected as a computer network using a modem and a communication medium and using a computer network on the World Wide Web as multiple servers connected to the Internet, wherein said computer operating system comprises:
(i) a protocol containing a global asynchronous serialized transaction identifier processing system comprising at least three software components:
(1) a serialized transaction identifier (STI) generating component,
(2) a cross-index validation component, and
(3) an asynchronous cross-system journaling component;
(ii) a plurality of compatible computer operating systems; and
(iii) a plurality of compatible computer software routines adapted to be executed on said compatible computer operating systems to program said computer operating systems to execute transactions providing back-up redundancy of transactions from other compatible computer operating systems.
